(19) United States
(12) Patent Application Publication
(10) Pub. No.: US 2025/0287322 A1
(43) Pub. Date: Sep. 11, 2025

(54) REDUCING CLIENT DETECTABILITY VIA SIGNAL STRENGTH OBSERVATION

(71) Applicant: Cisco Technology, Inc., San Jose, CA (US)

(72) Inventors: Ugo M. CAMPIGLIO, Morges (CH); Domenico FICARA, Essertines-Sur-Yverdon (CH); Jerome HENRY, Pittsboro, NC (US)

(21) Appl. No.: 19/040,668

(22) Filed: Jan. 29, 2025

Related U.S. Application Data
(60) Provisional application No. 63/563,805, filed on Mar. 11, 2024.

(51) Int. Cl. H04W 52/24

(52) U.S. Cl. CPC H04W 52/245; H04W 52/241

(57) ABSTRACT

Techniques and apparatus for reducing client detectability via signal strength observation are described. An example technique includes transmitting a first set of frames at a first transmit power level. Each of the first set of frames includes a first set of medium access control (MAC) layer parameters associated with a wireless device. A second transmit power level, different from the first transmit power level, for transmitting a second set of frames is determined. The second set of frames is transmitted at the second transmit power level after transmission of the first set of frames. Each of the second set of frames includes a second set of MAC layer parameters associated with the wireless device and different from the first set of MAC layer parameters.

### CROSS-REFERENCE TO RELATED APPLICATIONS

This application claims benefit of co-pending U.S. provisional patent application Ser. No. 63/563,805 filed Mar. 11, 2024. The aforementioned related patent application is herein incorporated by reference in its entirety.

### TECHNICAL FIELD

Embodiments presented in this disclosure generally relate to wireless communication. More specifically, embodiments disclosed herein relate to techniques for reducing client detectability via signal strength observation.

### BACKGROUND

In many wireless networks, clients (e.g., wireless devices or non-access point (AP) stations (STAs) (non-AP STAs)) can be susceptible to tracking by unauthorized (e.g., malicious) users. For example, an unauthorized user can gain access to a wireless network with a rogue AP and use the rogue AP to intercept packets and track the movement and activity of clients within the network based on the intercepted packets. To mitigate against such unauthorized tracking, certain wireless networks (e.g., Institute of Electrical and Electronic Engineers (IEEE) 802.11, also known as WiFi) have introduced several privacy enhancements that aim to provide clients with the ability to avoid being tracked within a network. These privacy enhancements generally focus on the medium access control (MAC) layer. For example, the client may perform periodic MAC address rotation while maintaining the connection with the AP, obfuscation of MAC header parameters (e.g., MAC address, packet number (PN), sequence number (SN), among others) that could help an observer (e.g., rogue AP or unauthorized user) identify which client is using the network, among other MAC layer privacy techniques.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 illustrates an example system, according to certain embodiments.

FIG. 2 is a flowchart of a method for reducing client detectability via signal strength observation, according to certain embodiments.

FIG. 3 is a flowchart of another method for reducing client detectability via signal strength observation, according to certain embodiments.

FIG. 4 illustrates an example computing device, according to certain embodiments.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment described herein is a method for wireless communication performed by a wireless device. The method includes transmitting a first set of frames at a first transmit power level. Each of the first set of frames includes a first set of medium access control (MAC) layer parameters associated with the wireless device. The method also includes determining a second transmit power level, different from the first transmit power level, for transmitting a second set of frames. The method further includes, after transmitting the first set of frames, transmitting the second set of frames at the second transmit power level. Each of the second set of frames includes a second set of MAC layer parameters associated with the wireless device and different from the first set of MAC layer parameters.

Another embodiment described herein is a wireless device. The wireless device includes one or more memories collectively storing instructions and includes one or more processors communicatively coupled to the one or more memories. The one or more processors are individually or collectively configured to execute the instructions to cause the wireless device to perform an operation. The operation includes transmitting a first set of frames at a first transmit power level. Each of the first set of frames includes a first set of medium access control (MAC) layer parameters associated with the wireless device. The operation also includes determining a second transmit power level, different from the first transmit power level, for transmitting a second set of frames. The operation further includes, after transmitting the first set of frames, transmitting the second set of frames at the second transmit power level. Each of the second set of frames includes a second set of MAC layer parameters associated with the wireless device and different from the first set of MAC layer parameters.

Another embodiment described herein is a non-transitory computer-readable medium. The non-transitory computer-readable includes computer-executable code, which when executed by one or more processors of a wireless device perform an operation. The operation includes transmitting a first set of frames at a first transmit power level. Each of the first set of frames includes a first set of medium access control (MAC) layer parameters associated with the wireless device. The operation also includes determining a second transmit power level, different from the first transmit power level, for transmitting a second set of frames. The operation further includes, after transmitting the first set of frames, transmitting the second set of frames at the second transmit power level. Each of the second set of frames includes a second set of MAC layer parameters associated with the wireless device and different from the first set of MAC layer parameters.

Other embodiments provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein.

### Example Embodiments

While certain wireless networks have introduced various MAC layer enhancements (e.g., periodic MAC address rotation, obfuscating MAC header parameters, etc.) that aim to provide clients with the ability to avoid being tracked within a network, in certain scenarios, such MAC layer enhancements alone may be insufficient at preventing clients from being tracked within the network. For example, whenever an observer (e.g., rogue AP) captures one or more frames (or packets) over-the-air (OTA) from a client, some physical layer (PHY) parameters may be collected by the observer for each detected frame. Such PHY parameters may include the signal strength (e.g., received signal strength indication (RSSI), reference signal received power (RSRP), signal-to-interference-plus-noise ratio (SINR), among other signal strength metrics) at which the frame is received, as an illustrative example. If the observer detects a new MAC address starting to transmit at the same signal strength as a previous detected MAC address that is no longer seen and the observer detects no other client with the same signal strength, then the observer can hypothesize that the same client is transmitting. That is, the observer may infer that the newly detected MAC address and the previously detected MAC address belong to the same client. In this situation, changing the MAC address has no effect on protecting the client's privacy.

Moreover, even if there are several MAC addresses detected with the same signal strength, certain MAC layer privacy techniques, such as MAC address rotation, may still make it easier to identify which client has changed its MAC address. In cases of MAC address rotation, for example, the number of clients participating in a group epoch and hence rotating MAC address at the same time may be a subset of the number of MAC addresses with a given signal strength, making assumptions to identify which client is which easier. Consider an illustrative scenario in which client A is located far from the observer and clients B and C are located closer to the observer. In this scenario, the observer may initially detect a MAC address A (for client A), a MAC address B (for client B), and a MAC address C (for client C). If client A then changes (or rotates) its MAC address from MAC address A to MAC address D, then the observer may still be able to determine that (i) the signal strength of the newly detected MAC address D is different from (e.g., lower than) the signal strengths of MAC addresses B and C and (ii) the signal strength of the newly detected MAC address D is approximately the same as the signal strength of the previously detected MAC address A, which is no longer seen. In this scenario, the observer may infer that detected MAC addresses A and D belong to the same client A.

Certain embodiments described herein provide techniques, systems, and apparatus for reducing client detectability via signal strength observation within a wireless network. More specifically, embodiments provide techniques that allow a client to adapt (or vary) its MAC layer fingerprint as well as its PHY fingerprint when operating within a wireless network in order to reduce the ability of an observer to track the client within the network.

As described herein, each client within the wireless network generally has a respective MAC layer fingerprint and a respective PHY fingerprint. The MAC layer fingerprint may include a set of MAC layer parameters, such as MAC address, PN, and association identifier (AID), as illustrative examples. The PHY fingerprint may include a set of PHY parameters, such as the respective signal strength (e.g., RSSI, RSRP, SINR, etc.) at which each frame transmitted by the client is detected, modulation and coding scheme (MCS) (index) being used by the client, number of spatial streams used by the client, bandwidth (BW) used by the client, transmit power level used by the client, and set of resource units (RUs) used by the client, as illustrative examples. Note, the transmit power level used by the client for transmission of a frame(s) may impact the signal strength at which the frame(s) is detected by a receiver.

In certain embodiments, to reduce the traceability of a client through the client's PHY fingerprint, the client changes the transmit power level at which the client transmits frames when the client changes its MAC address. For example, the client may change its transmit power during the same procedure where it rotates its MAC address, e.g., via mass MAC address rotation or individual MAC address rotation. Changing the transmit power concurrently with a MAC address change using techniques described herein may increase the client's ability to preserve the client's privacy. For example, assuming there is an observer (or eavesdropper) on the wireless medium, the observer will detect frames from different MAC addresses and receive the frames at different signal strengths, making it more difficult for the eavesdropper to correlate the frame(s) from the newly detected MAC address with the frame(s) from the previously detected MAC address. This, in turn, makes it more difficult for the eavesdropper to assume that the frames come from the same client.

In certain embodiments, in addition to changing the transmit power at which the client transmits frames, the client may change one or more additional PHY parameters (e.g., MCS index, number of spatial streams, bandwidth, and RUs if orthogonal frequency division multiple access (OFDMA) is used) when the client changes its MAC address. Because these additional parameters can help to identify the client, changing one or more of these parameters in addition to the transmit power may make it more difficult for an eavesdropper to track the client, thereby further increasing the client's ability to preserve its privacy.

Note, the techniques described herein for reducing client detectability via signal strength observation may be incorporated into (such as implemented within or performed by) a variety of wired or wireless apparatuses (such as nodes). In some implementations, a node includes a wireless node. Such wireless nodes may provide, for example, connectivity to or from a network (such as a wide area network (WAN) such as the Internet or a cellular network) via a wired or wireless communication link. In some implementations, a wireless node may include an AP, a controller, or a client.

Although the terms “first,” “second,” “third,” etc., may be used herein to describe various elements, components, regions, layers and/or sections, these elements, components, regions, layers and/or sections should not be limited by these terms. These terms may be only used to distinguish one element, component, region, layer or section from another element, component, region, layer, or section. Terms such as “first,” “second,” and other numerical terms, when used herein, do not imply a sequence or order unless clearly indicated by the context. Thus, a first element, component, region, layer, or section discussed herein could be termed a second element, component, region, layer, or section without departing from the teachings of the example embodiments.

As used herein, a hyphenated form of a reference numeral refers to a specific instance of an element and the un-hyphenated form of the reference numeral refers to the collective element. Thus, for example, device “12-1” refers to an instance of a device class, which may be referred to collectively as devices “12” and any one of which may be referred to generically as a device “12”.

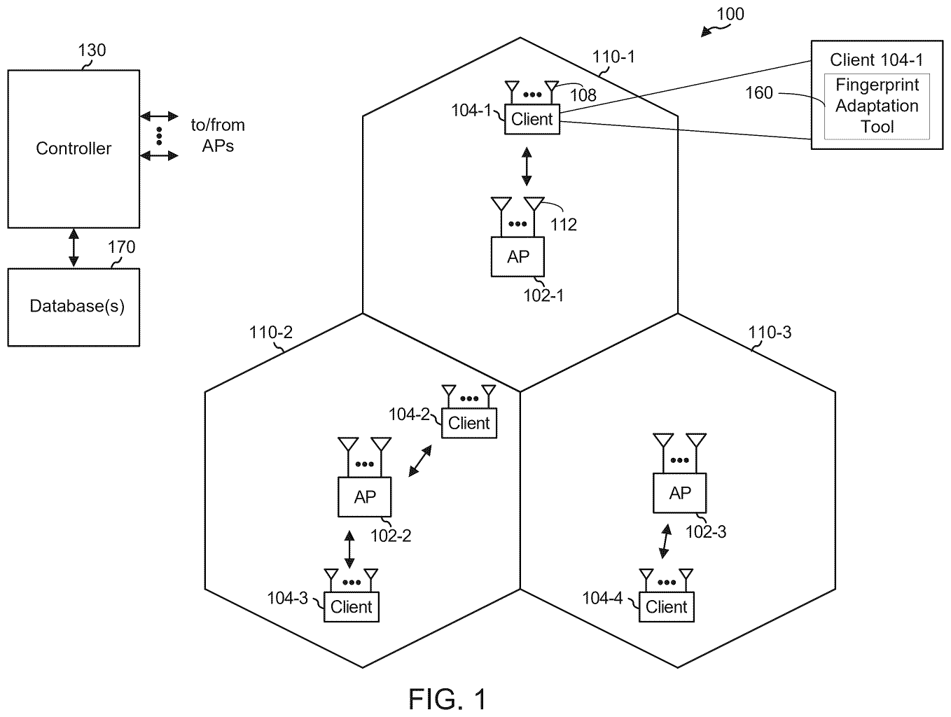

FIG. 1 illustrates an example system 100 in which one or more techniques described herein can be implemented, according to certain embodiments. As shown, the system 100 includes, without limitation, one or more APs (e.g., AP 102-1, AP 102-2, and AP 102-3), one or more clients (e.g., client 104-1, client 104-2, client 104-3, and client 104-4), a controller 130, and one or more databases 170. In certain embodiments, the system 100 may implement a wireless network according to one or more wireless communication standards, such as one or more of the IEEE 802.11 standards.

An AP is generally a fixed station that communicates with client(s) and may be referred to as a base station, a wireless device, a network device, or some other terminology. A client may be fixed or mobile and also may be referred to as a mobile station (STA), a client STA, a STA, a wireless device, a non-AP multi-link device (MLD), a non-AP STA, or some other terminology. Note that while a certain number of APs and clients are depicted, the system 100 may include any number of APs and clients.

As used herein, an AP along with the clients associated with the AP (e.g., within the coverage area (or cell) of the AP) may be referred to as a basic service set (BSS). Here, AP 102-1 is the serving AP for client 104-1, AP 102-2 is the serving AP for clients 104-2 and 104-3, and AP 102-3 is the serving AP for client 104-4. The AP 102-1, AP 102-2, and AP 102-3 are neighboring (peer) APs. The APs 102 may communicate with one or more clients 104 on the downlink and uplink. The downlink (e.g., forward links) is the communication link(s) from the AP(s) 102 to the client(s) 104, and the uplink (e.g., reverse links) is the communication link(s) from the client(s) 104 to the AP(s) 102. In some cases, a client may also communicate peer-to-peer with another client.

As shown in FIG. 1, each client 104 includes one or more radios 108. The client 104 can use one or more of the radios 108 to form links with an AP 102. As also shown, each AP 102 includes one or more radios 112 that the AP 102 can use to form links with one or more clients 104 and/or one or more APs 102. In general, the AP(s) 102 and the client(s) 104 may form any suitable number of links for communication using any suitable frequencies and using any suitable communication protocols. In some instances, a client 104 may form multiple links with a single AP 102.

In certain embodiments, the APs 102 may be controlled or managed at least partially by the controller 130. Here, the controller 130 couples to and provides coordination and control for the APs 102 1-3. For example, the controller 130 may handle adjustments to RF power, channels, authentication, and security for the APs. The controller 130 may also coordinate the links formed by the client(s) 104 with the APs 102. The controller 130 and APs 102 may utilize a same control plane protocol.

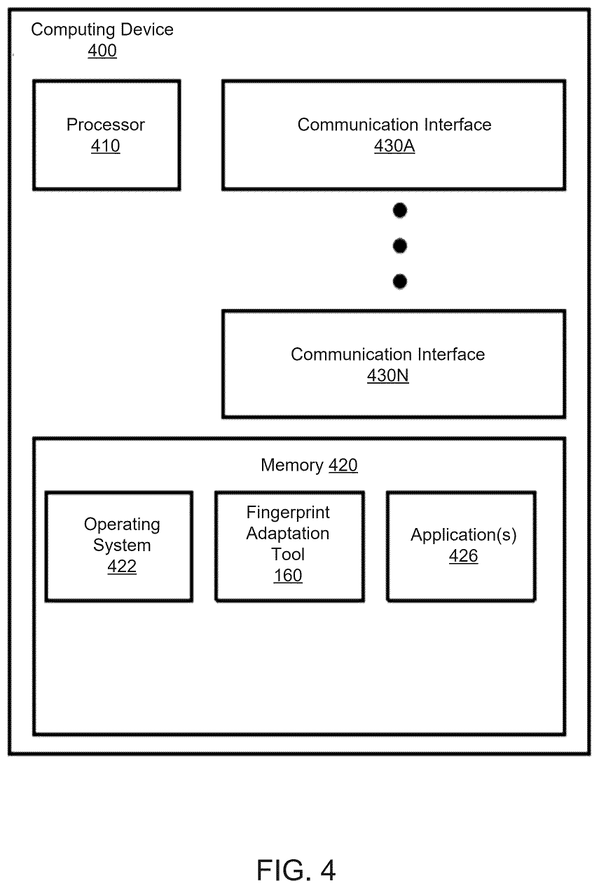

The operations of the controller 130 may be implemented by any device or system, and may be combined or distributed across any number of systems. For example, the controller 130 may be a wireless local area network (WLAN) controller for the deployment of APs 102 within the system 100. In some examples, the controller 130 is included within or integrated with an AP 102 and coordinates the links formed by that AP 102 (or otherwise provides control for that AP). For example, each AP 102 may include a controller that provides control for that AP. In some examples, the controller 130 is separate from the APs 102 and provides control for those APs. In FIG. 1, for example, the controller 130 may communicate with the APs 102 1-3 via a (wired or wireless) backhaul. The APs 102 1-3 may also communicate with one another, e.g., directly or indirectly via a wireless or wireline backhaul. The database(s) 170 is representative of a storage system(s) that may include, without limitation, radio resource configurations and radio resource management (RRM) information, among other information. Example hardware that may be included in a client 104 is discussed in greater detail with respect to FIG. 4.

In certain embodiments, the client(s) 104 may be configured to perform one or more techniques described herein to reduce its detectability within the system 100 via signal strength observation, e.g., by one or more observers. As shown, the client 104 includes a fingerprint adaptation tool 160, which is configured to perform one or more techniques described herein and is described in greater detail below. The fingerprint adaptation tool 160 may be implemented with hardware, software, or combinations thereof.

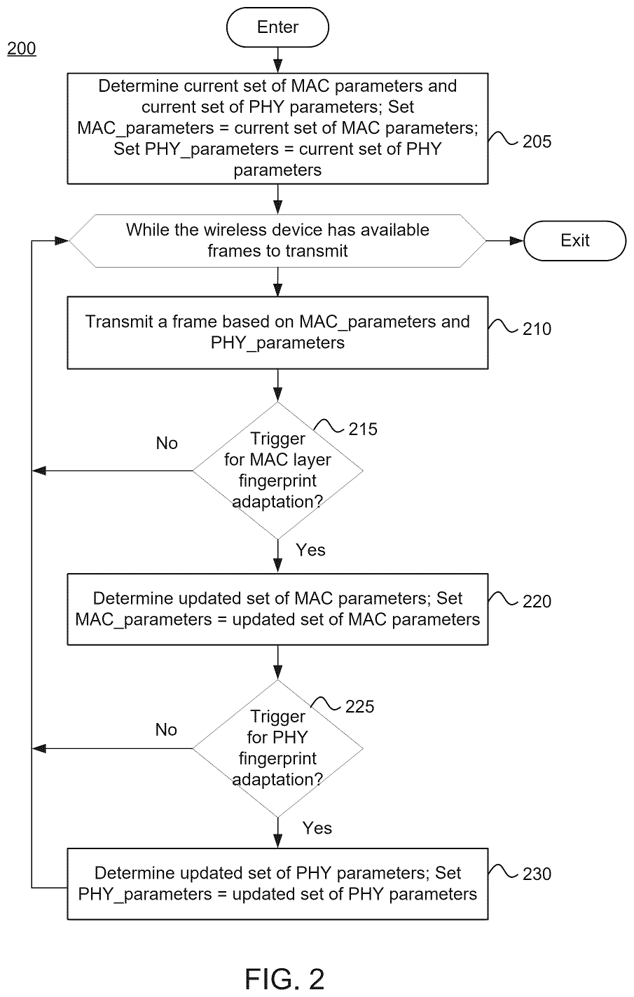

FIG. 2 is a flowchart of a method 200 for wireless communication, according to certain embodiments. The method 200 may be performed by a wireless device, such as a client 104. For example, the fingerprint adaptation tool 160 may perform one or more of the blocks depicted in method 200. In certain embodiments, the method 200 is performed to reduce detectability of the wireless device via signal strength observation (e.g., RSSI observation).

Method 200 may enter at block 205, where the wireless device determines a (initial) set of MAC layer parameters associated with the wireless device and a (initial) set of PHY parameters to use for transmission of one or more frames. The set of MAC layer parameters may include a MAC address associated with the wireless device, PN, SN, and AID, as illustrative examples. The set of PHY parameters may include a MCS, a number of spatial streams, a transmit power level, a bandwidth, and a set of RUs (assuming OFDMA is used), as illustrative examples. As noted, the transmit power level used for transmission of frame(s) may impact the signal strength at which the frame(s) transmitted by the wireless device is detected by a receiver.

The wireless device may initialize or set MAC_parameters equal to a current set of MAC layer parameters and initialize or set PHY_parameters equal to a current set of PHY parameters. In certain examples, the current set of MAC layer parameters may be a default set of MAC layer parameters configured for the wireless device, and the current set of PHY parameters may be a default set of PHY parameters configured for the wireless device.

In certain examples, the current set of MAC layer parameters may be a previously used set of MAC layer parameters (e.g., set of MAC layer parameters used in a prior time window (or interval), such as an epoch), and the current set of PHY parameters may be a previously used set of PHY parameters (e.g., set of PHY parameters used in prior time window (or interval), such as an epoch). As used herein, an epoch generally refers to a time window in which a set of enhanced distribution parameters (EDP) parameters remains constant. EDP parameters (e.g., EDP parameters defined in IEEE 802.11bi) may be used to control the anonymization of certain fields, such as MAC header fields, within wireless frames to prevent tracking of individual devices on a network. The duration of an epoch may be seconds, minutes, hours, or some amount of time.

One or more of blocks 210, 215, 220, 225, and 230 may be performed while the wireless device has one or more available frames to transmit. At block 210, the wireless device transmits a frame based on MAC_parameters and PHY_parameters. For example, the frame may include the MAC_parameters (e.g., in a MAC header of the frame) and may be transmitted according to the PHY_parameters (e.g., transmitted at the MCS, transmitted using the number of spatial streams, transmitted at the transmit power level, transmitted using the bandwidth, and transmitted on the set of RUs, etc.).

As noted, in some cases, the wireless device may change (or adapt) its MAC layer fingerprint over time while transmitting frames in order to make it more difficult for an observer to track the wireless device within a network. In some examples, the wireless device may change its MAC layer fingerprint by changing its MAC address (e.g., performing MAC address rotation). In some examples, the wireless device may change its MAC layer fingerprint by obfuscating one or more MAC header parameters (e.g., MAC address, PN, SN, AID, etc.). At block 215, the wireless device determines whether a MAC layer fingerprint adaptation is triggered for the wireless device. In certain embodiments, the trigger for the MAC layer fingerprint adaptation may include occurrence of a start of a predefined time window (or interval), such as an epoch, configured for the wireless device (e.g., by an AP).

If the MAC layer fingerprint adaptation is not triggered, then the method 200 proceeds to block 210 (assuming there is an additional frame(s) available for the wireless device to transmit). For example, assuming the MAC layer fingerprint adaptation is not triggered and there is an additional frame(s) available for the wireless device to transmit, then the wireless device may transmit another frame(s) based on the same MAC_parameters and same_PHY parameters as the previously transmitted frame(s).

On the other hand, if the MAC layer fingerprint adaptation is triggered (e.g., there is an occurrence of a start of a next predefined time window (or interval), such as an epoch), then the method 200 proceeds to block 220. At block 220, the wireless device determines an updated set of MAC layer parameters, and sets MAC_parameters equal to the updated set of MAC layer parameters. The updated set of MAC layer parameters may include at least one of a different MAC address, a different SN, a different PN, or a different AID compared to the previous (e.g., current) set of MAC layer parameters.

As noted herein, in some scenarios, performing MAC layer fingerprint adaptation alone may not be sufficient to prevent tracking of the wireless device within the network. In such cases, the wireless device may perform a PHY fingerprint adaptation along with the MAC layer fingerprint adaptation. At block 225, for example, the wireless device determines whether PHY fingerprint adaptation is triggered. In certain embodiments, the wireless device determines PHY fingerprint adaptation is triggered when there has been an adaptation of the MAC layer fingerprint (e.g., upon the occurrence of a start of each time window, such as an epoch).

In certain embodiments, the wireless device determines PHY fingerprint adaptation is triggered when a predetermined number of adaptations of the MAC layer fingerprint has occurred. For example, instead of determining the PHY fingerprint is triggered at the start of each time window (e.g., epoch), the wireless device may determine that PHY fingerprint adaptation is triggered after a predetermined number of time windows (e.g., number of epochs) has elapsed.

In certain embodiments, the wireless device determines PHY fingerprint adaptation is triggered when particular time windows of multiple time windows configured for the wireless device occur. For example, the wireless device may determine that PHY fingerprint adaptation is triggered for a particular subset of epochs configured for the wireless device.

If the wireless device determines PHY adaptation is not triggered, then the method 200 proceeds to block 210 (assuming there is an additional frame(s) available for the wireless device to transmit). For example, assuming the PHY fingerprint adaptation is not triggered and there is an additional frame(s) available for the wireless device to transmit, then the wireless device may transmit another frame(s) based on the updated set MAC layer parameters (determined in block 220) and same PHY_parameters as the previously transmitted frame(s).

On the other hand, if the PHY fingerprint adaptation is triggered, then the method 200 proceeds to block 230. At block 230, the wireless device determines an updated set of PHY parameters, and sets PHY_parameters equal to the updated set of PHY parameters. The updated set of PHY parameters may include at least one of a different MCS, different transmit power level, different number of spatial streams, different bandwidth, or different resource allocation (e.g., different set of RUs) (assuming OFDMA is employed) than the previous (e.g., current) set of PHY parameters.

In certain embodiments, the wireless device may determine the updated set of PHY parameters based on one or more conditions of the wireless medium (e.g., wireless channel) (referred to herein as channel conditions) between the wireless device and an AP associated with the wireless device. The channel conditions may be determined based on at least one of: (i) a signal strength of at least one frame received at the wireless device (e.g., the RSSI at which the client receives frames from the AP), (ii) one or more transmit power restrictions for the wireless device (e.g., transmit power restrictions on the frequency band(s) that the wireless device operates on), (iii) an amount of interference on the wireless channel between the wireless device and AP (e.g., co-channel interferences), or (iv) any combination thereof.

In certain embodiments, the wireless device may employ an algorithm to determine the updated set of PHY parameters. In some embodiments, the wireless device and the AP may negotiate and agree on a long-term algorithm that is used to determine the updated set of PHY parameters (e.g., next transmit power changes), or the subset of time windows (e.g., subset of epochs) when such updates to the PHY parameters will occur (e.g., the wireless device may not be able to update the set of PHY parameters at each time window).

In certain embodiments, as part of the negotiation, a key is exchanged whereby the AP and the wireless device agree on the updated set of PHY parameters (e.g., the transmit power change, MCS change, change in the number of spatial streams, change in bandwidth, change in RUs, etc.) along with the updated set of MAC layer parameters (e.g., change in MAC address). For example, at least one portion of the updated set of MAC layer parameters may be indicative of the updated set of PHY parameters. For instance, one byte of the next MAC address may be indicative of the next transmit power level that will be used by the wireless device.

In certain embodiments, as part of the negotiation, for each respective PHY parameter, the AP and the wireless device may agree on a range of values that can be used for the PHY parameter without impacting the overall quality of the wireless service for the wireless device. That is, each range of values for each respective PHY parameter may be determined, such that the wireless device can achieve and maintain a target quality of service (QOS) for the wireless device. In such embodiments, the wireless device can autonomously update (or change) its PHY parameters within the respective ranges.

In certain embodiments, rather than perform a negotiation with the AP, for each respective PHY parameter, the wireless device may autonomously determine, for each PHY parameter, the updated value it wants to use for the PHY parameter. In such embodiments, the wireless device may not be configured with a range of values for each respective PHY parameter to use for updating that PHY parameter.

In certain embodiments, the wireless device determines the updated set of PHY parameters based on feedback received from the AP. For example, for one or more of the PHY parameters, the AP may provide feedback to the wireless device about the effect of the updated PHY parameter(s). For instance, if the wireless device lowers its transmit power level, then the signal strength (e.g., RSSI) at which the AP receives messages from the wireless device may be lower. In some cases, the lower transmit power level may impact the ability of the AP to reliably receive and decode messages from the wireless device (e.g., the AP may not be able to demodulate the message that is sent at the same data rate/same MCS but with lower transmit power level). Accordingly, when the AP receives information from the wireless device about the wireless device's transmit power level, the AP may determine an impact that the wireless device's transmit power level has on the communication performance of the wireless device and determine a recommended set of PHY parameters for the wireless device that will achieve a target QoS for the wireless device. The AP may provide feedback including the recommended set of PHY parameters to the wireless device.

By way of example, if the wireless device informs the AP that it is sending messages at a transmit power level of 20 decibel-milliwatts (dBm), but the AP receives the messages at −62 dBm, then the AP can determine, based on the position of the wireless device, how much margin the wireless device has to lower its transmit power level further and at what point the current MCS of the wireless device may not be feasible. The AP may provide this information in the form of feedback to the wireless device.

By way of another example, the AP may provide a MCS recommendation or link budget recommendation that will allow the wireless device to determine how much it can lower its transmit power level without changing its MCS. For example, the AP may inform the wireless device that the wireless device can lower its transmit power level by 3 dBm and still stay at a current MCS, but if the wireless device lowers its transmit power level by greater than 3 dBm, then the wireless device may have to switch to a lower MCS. Note while certain examples described herein use transmit power level and/or MCS as reference examples of PHY parameters that the wireless device may receive feedback on from the AP, it should be understood that the wireless device may receive feedback from the AP regarding any PHY parameter, such as transmit power level, MCS (index), number of spatial streams, bandwidth, and set of RUs, as illustrative examples.

After block 230, the method 200 proceeds to block 210 (assuming there is an additional frame(s) available for the wireless device to transmit). For example, assuming there is an additional frame(s) available for the wireless device to transmit, then the wireless device may transmit another frame(s) based on the updated set of MAC layer parameters (determined in block 220) and the updated set of PHY parameters (determined in block 230).

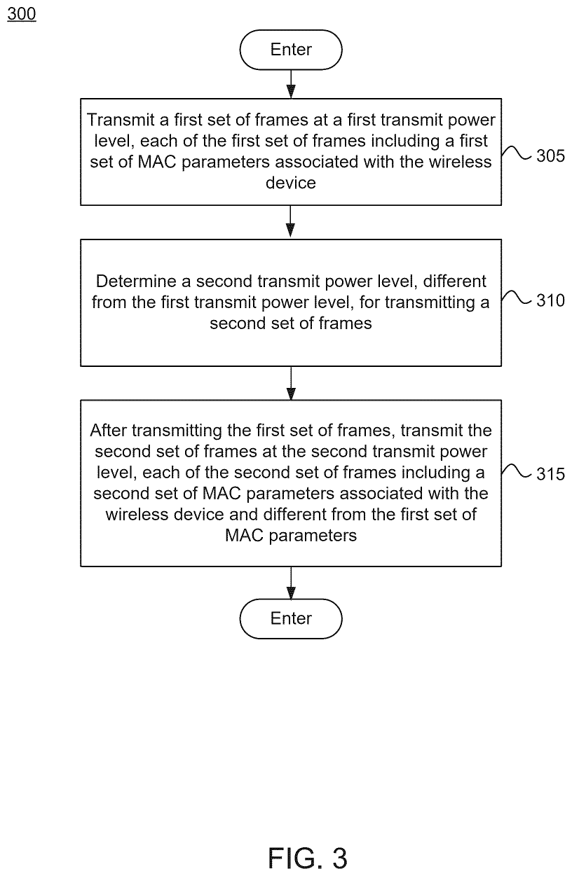

FIG. 3 is a flowchart of another method 300 for wireless communication, according to certain embodiments. The method 300 may be performed by a wireless device, such as a client 104. For example, the fingerprint adaptation tool 160 may perform one or more of the blocks depicted in method 300. In certain embodiments, the method 300 is performed to reduce detectability of the wireless device via signal strength observation (e.g., RSSI observation).

Method 300 may enter at block 305, where the wireless device transmits a first set of frames at a first transmit power level. Each of the first set of frames includes a first set of MAC layer parameters associated with the wireless device.

At block 310, the wireless device determines a second transmit power level, different from the first transmit power level, for transmitting a second set of frames. The second transmit power level may be lower or higher than the first transmit power level.

At block 315, the wireless device, after transmitting the first set of frames, transmits the second set of frames at the second transmit power level. Each of the second set of frames includes a second set of MAC layer parameters that is associated with the wireless device and that is different from the first set of MAC layer parameters.

In certain embodiments, the second transmit power level is determined based on the second set of MAC layer parameters. For example, the first set of MAC layer parameters may include a first MAC address associated with the wireless device, the second set of MAC layer parameters may include a different second MAC address associated with the wireless device, and the second transmit power level may be determined based on at least a portion (e.g., one byte) of the second MAC address.

In certain embodiments, the second transmit power level is determined based on one or more conditions of a communication channel between the wireless device and AP. The one or more conditions may be based on at least one of a signal strength of at least one frame received at the wireless device, one or more transmit power restrictions for the wireless device, or an amount of interference on the communication channel.

In certain embodiments, determining the second transmit power level involves selecting the second transmit power level from a range of transmit power levels. In some cases, the range of transmit power levels may be determined based on a negotiation between the wireless device and AP. In some cases, the range of transmit power levels is determined based on feedback received from an AP regarding the first transmit power level. In some cases, each transmit power level within the range of transmit power levels may be associated with a target QoS for the wireless device.

In certain embodiments, the method 300 further involves generating the second set of MAC layer parameters. In such embodiments, the second transmit power level may be determined responsive to the generation of the second set of MAC layer parameters.

In certain embodiments, the second transmit power level is determined upon determining an occurrence of a predetermined time window. The predetermined time window may be based on a predefined number of epochs (e.g., EDP epoch defined in IEEE 802.11bi).

In certain embodiments, the first set of frames is transmitted according to a first set of PHY parameters. The first set of PHY parameters may include the first transmit power level along with other PHY parameters, such as MCS (index), number of spatial streams, bandwidth, and set of RUs, as illustrative examples. In such embodiments, the method 300 may further involve generating a second set of PHY parameters different from the first set of PHY parameters. The second set of frames may be transmitted according to the second set of PHY parameters. The second set of PHY parameters may include the second transmit power level along with other PHY parameters such as at least one of a different MCS, a different number of spatial streams, a different bandwidth, or a different set of RUs than the first set of PHY parameters.

For example, the wireless device may decide to change its transmit power level together with its MCS index, number of spatial streams, bandwidth, and/or its set of RUs (if OFDMA is used), because these are additional PHY parameters that can help identify the client. In some embodiments, the updated PHY parameters can be temporal. For example, the wireless device can select to use a random value for its next bandwidth, next number of spatial streams, and/or next MCS within an acceptable set for its first exchanges with the new MAC address. Those PHY parameters can then be updated again during the next time window (e.g., epoch).

In certain embodiments, the second set of PHY parameters (including the second transmit power level) is generated based on the second set of MAC layer parameters, based on a negotiation between the wireless device and AP, based on feedback received from the AP, or any combination thereof.

FIG. 4 illustrates an example computing device 400, according to one embodiment. The computing device 400 can be configured to perform one or more techniques described herein for reducing client detectability via signal strength observation. For example, the computing device 400 can perform method 200, method 300, and any other techniques (or combination of techniques) described herein. The computing device 400 may be representative of a wireless device (e.g., client 104). The computing device 400 includes, without limitation, a processor 410, a memory 420, and one or more communication interfaces 430a-n (generally, communication interface 430). In one example, the communication interface 430 includes a radio.

The processor 410 may be any processing element capable of performing the functions described herein. The processor 410 represents a single processor, multiple processors, a processor with multiple cores, and combinations thereof. The communication interfaces 430 (e.g., radios) facilitate communications between the computing device 400 and other devices. The communications interfaces 430 may include wireless communications antennas and various wired communication ports.

The memory 420 may be either volatile or non-volatile memory and may include RAM, flash, cache, disk drives, and other computer readable memory storage devices. Although shown as a single entity, the memory 420 may be divided into different memory storage elements such as RAM and one or more hard disk drives. As shown, the memory 420 includes various instructions that are executable by the processor 410 to provide an operating system 422 to manage various functions of the computing device 600. The memory 420 also includes fingerprint adaptation tool 160 and one or more application(s) 426.

The computing device 400 may include storage (not shown). In some cases, the storage may be a disk drive or flash storage device. In some cases, the storage may be a combination of fixed and/or removable storage devices, such as fixed disc drives, solid state drives, removable memory cards, optical storage, network attached storage (NAS), or a storage area-network (SAN).

Advantageously, using the techniques described herein to couple MAC address rotations for clients with changes in the client's transmit power may significantly increase the difficulty for an observer (e.g., rogue AP) to correlate between old and new MAC addresses for a client following rotation. As such, the techniques described herein can significantly increase the client's privacy within the network.

Example Clauses

Implementation examples are described in the following numbered clauses:

Clause 1: A method for wireless communication performed by a wireless device, comprising: transmitting a first set of frames at a first transmit power level, each of the first set of frames comprising a first set of medium access control (MAC) layer parameters associated with the wireless device; determining a second transmit power level, different from the first transmit power level, for transmitting a second set of frames; and after transmitting the first set of frames, transmitting the second set of frames at the second transmit power level, each of the second set of frames comprising a second set of MAC layer parameters associated with the wireless device and different from the first set of MAC layer parameters.

Clause 2: The method of Clause 1, wherein the second transmit power level is determined based on the second set of MAC layer parameters.

Clause 3: The method in accordance with any of Clauses 1-2, wherein: the first set of MAC layer parameters comprises a first MAC address associated with the wireless device; the second set of MAC layer parameters comprises a second MAC address associated with the wireless device and different from the first MAC address; and the second transmit power level is determined based on at least a portion of the second MAC address.

Clause 4: The method in accordance with any of Clauses 1-3, wherein the second transmit power level is determined based on one or more conditions of a communication channel between the wireless device and an access point (AP).

Clause 5: The method of Clause 4, wherein the one or more conditions are based on at least one of a signal strength of at least one frame received at the wireless device, one or more transmit power restrictions for the wireless device, or an amount of interference on the communication channel.

Clause 6: The method in accordance with any of Clauses 1-5, wherein determining the second transmit power level comprises selecting the second transmit power level from a range of transmit power levels.

Clause 7: The method of Clause 6, wherein the range of transmit power levels is determined based on a negotiation between the wireless device and an access point (AP).

Clause 8: The method in accordance with any of Clauses 6-7, wherein the range of transmit power levels is determined based on feedback received from an access point (AP), the feedback being associated with the first transmit power level.

Clause 9: The method in accordance with any of Clauses 6-8, wherein each transmit power level within the range of transmit power levels is associated with a target quality of service (QoS) for the wireless device.

Clause 10: The method in accordance with any of Clauses 1-9, further comprising generating the second set of MAC layer parameters, wherein the second transmit power level is determined responsive to the generation of the second set of MAC layer parameters.

Clause 11: The method in accordance with any of Clauses 1-9, wherein the second transmit power level is determined upon determining an occurrence of a predetermined time window.

Clause 12: The method of Clause 11, wherein the predetermined time window is based on a predefined number of epochs.

Clause 13: The method in accordance with any of Clauses 1-12, wherein the first set of frames is transmitted according to a first set of physical layer (PHY) parameters, the method further comprising generating a second set of PHY parameters different from the first set of PHY parameters, wherein the second set of frames is transmitted according to the second set of PHY parameters.

Clause 14: The method of Clause 13, wherein the second set of PHY parameters comprises at least one of a different modulation and coding scheme (MCS), a different number of spatial streams, a different bandwidth, or a different set of resource units (RUs) than the first set of PHY parameters.

Clause 15: The method in accordance with any of Clauses 13-14, wherein the second set of PHY parameters is generated based on the second set of MAC layer parameters, based on a negotiation between the wireless device and an access point (AP), based on feedback received from the AP, or any combination thereof.

Clause 16: A wireless device comprising: one or more memories collectively storing instructions; and one or more processors communicatively coupled to the one or more memories, the one or more processors being individually or collectively configured to execute the instructions to cause the computing device to perform a method in accordance with any of Clauses 1-15.

Clause 17: A non-transitory computer-readable medium comprising computer-executable code, which when executed by one or more processors of a wireless device perform a method in accordance with any of Clauses 1-15.

Clause 18: An apparatus comprising means for performing a method in accordance with any of Clauses 1-15.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method for wireless communication performed by a wireless device, comprising:
transmitting a first set of frames at a first transmit power level, each of the first set of frames comprising a first set of medium access control (MAC) layer parameters associated with the wireless device;
determining a second transmit power level, different from the first transmit power level, for transmitting a second set of frames; and
after transmitting the first set of frames, transmitting the second set of frames at the second transmit power level, each of the second set of frames comprising a second set of MAC layer parameters associated with the wireless device and different from the first set of MAC layer parameters.

2. The method of claim 1, wherein the second transmit power level is determined based on the second set of MAC layer parameters.

3. The method of claim 2, wherein:
the first set of MAC layer parameters comprises a first MAC address associated with the wireless device;
the second set of MAC layer parameters comprises a second MAC address associated with the wireless device and different from the first MAC address; and
the second transmit power level is determined based on at least a portion of the second MAC address.

4. The method of claim 1, wherein the second transmit power level is determined based on one or more conditions of a communication channel between the wireless device and an access point (AP).

5. The method of claim 4, wherein the one or more conditions are based on at least one of a signal strength of at least one frame received at the wireless device, one or more transmit power restrictions for the wireless device, or an amount of interference on the communication channel.

6. The method of claim 1, wherein determining the second transmit power level comprises selecting the second transmit power level from a range of transmit power levels.

7. The method of claim 6, wherein the range of transmit power levels is determined based on a negotiation between the wireless device and an access point (AP).

8. The method of claim 6, wherein the range of transmit power levels is determined based on feedback received from an access point (AP), the feedback being associated with the first transmit power level.

9. The method of claim 6, wherein each transmit power level within the range of transmit power levels is associated with a target quality of service (QoS) for the wireless device.

10. The method of claim 1, further comprising generating the second set of MAC layer parameters, wherein the second transmit power level is determined responsive to the generation of the second set of MAC layer parameters.

11. The method of claim 1, wherein the second transmit power level is determined upon determining an occurrence of a predetermined time window.

12. The method of claim 11, wherein the predetermined time window is based on a predefined number of epochs.

13. The method of claim 1, wherein the first set of frames is transmitted according to a first set of physical layer (PHY) parameters, the method further comprising generating a second set of PHY parameters different from the first set of PHY parameters, wherein the second set of frames is transmitted according to the second set of PHY parameters.

14. The method of claim 13, wherein the second set of PHY parameters comprises at least one of a different modulation and coding scheme (MCS), a different number of spatial streams, a different bandwidth, or a different set of resource units (RUs) than the first set of PHY parameters.

15. The method of claim 13, wherein the second set of PHY parameters is generated based on the second set of MAC layer parameters, based on a negotiation between the wireless device and an access point (AP), based on feedback received from the AP, or any combination thereof.

16. A wireless device comprising:
one or more memories collectively storing instructions; and
one or more processors communicatively coupled to the one or more memories, the one or more processors being individually or collectively configured to execute the instructions to cause the wireless device to perform an operation comprising:
transmitting a first set of frames at a first transmit power level, each of the first set of frames comprising a first set of medium access control (MAC) layer parameters associated with the wireless device;
determining a second transmit power level, different from the first transmit power level, for transmitting a second set of frames; and
after transmitting the first set of frames, transmitting the second set of frames at the second transmit power level, each of the second set of frames comprising a second set of MAC layer parameters associated with the wireless device and different from the first set of MAC layer parameters.

17. The wireless device of claim 16, wherein the second transmit power level is determined based on the second set of MAC layer parameters.

18. The wireless device of claim 17, wherein:
the first set of MAC layer parameters comprises a first MAC address associated with the wireless device;
the second set of MAC layer parameters comprises a second MAC address associated with the wireless device and different from the first MAC address; and
the second transmit power level is determined based on at least a portion of the second MAC address.

19. The wireless device of claim 16, wherein the second transmit power level is determined based on one or more conditions of a communication channel between the wireless device and an access point (AP).

20. A non-transitory computer-readable medium comprising computer-executable code, which when executed by one or more processors of a wireless device perform an operation comprising:
transmitting a first set of frames at a first transmit power level, each of the first set of frames comprising a first set of medium access control (MAC) layer parameters associated with the wireless device;
determining a second transmit power level, different from the first transmit power level, for transmitting a second set of frames; and
after transmitting the first set of frames, transmitting the second set of frames at the second transmit power level, each of the second set of frames comprising a second set of MAC layer parameters associated with the wireless device and different from the first set of MAC layer parameters.
